(19) United States
(12) Patent Application Publication
(10) Pub. No.: US 2010/0216015 A1
(43) Pub. Date: Aug. 26, 2010

(54) BATTERY PACK AND BATTERY PACK MANUFACTURING METHOD

(76) Inventors: Tatsuya Kamada, Osaka (JP); Takashi Sumida, Osaka (JP); Hideaki Ebihara, Osaka (JP)

Correspondence Address: BIRCH STEWART KOLASCH & BIRCH, PO BOX 747, FALLS CHURCH, VA, 22040-0747, US

(21) Appl. No.: 12/708,777

(22) Filed: Feb. 19, 2010

(30) Foreign Application Priority Data
Feb. 20, 2009 (JP) 2009-038244

(51) Int. Cl. H01M 2/30; H01M 2/00

(52) U.S. Cl. 429/178; 29/623.1

(57) ABSTRACT

In a battery pack in which accessory parts are fitted to a unit cell, the unit cell has a terminal portion, accessory parts include an electrical-connection use lead and a frame having an engagement portion to be engaged with the lead, and the lead and the terminal portion are bonded together by welding while the lead is engaged with the engagement portion. As a result of this, movement of the frame can be inhibited under action of external force. Moreover, in a structure in which an exterior cover is fitted to the frame or in which resin mold is integrally molded with the frame, movement of these members can be inhibited when external force acts on the exterior cover or the resin mold.

### BACKGROUND OF THE INVENTION

1. Field of the Invention

The present invention relates to a battery pack, as well as a manufacturing method therefor, in which leads for electrical connections are welded to its terminal portions.

2. Description of Related Art

With the trend toward thinner and smaller battery packs in recent years, there is a current tendency that, as the mainstream of battery packs, an positive lead and a negative lead are taken from the sealing side of a unit cell upper part so as to provide an exterior part in which a protective circuit and protective elements are integrated in upper part of the unit cell.

FIG. 13 shows an exploded perspective view of an example of a conventional battery pack. The battery pack 120 shown in this figure, which is an example of an integrally molded structure that the exterior part is covered with a resin mold, has a thinned flat quadrilateral shape whose depth is smaller in comparison to its longitudinal height and lateral length. One end of a lead (electrode lead) 123 is welded to a positive terminal of a unit cell 121, while one end of a lead 125 is welded to a negative terminal 124. The other end of the lead 123 is welded to a protective circuit 126, while the other end of the lead 125 is welded to one end of a protective element 127. The other end of the protective element 127 is welded to one end of a lead 128, while the other end of the lead 128 is welded to the protective circuit 126. Between the protective circuit 126 and the unit cell 121 is interposed an insulating plate 130.

By injection of resin to between the unit cell 121 and an exterior cover 129, various components of the upper part of the unit cell 121, the exterior cover 129 and the resin are integrally molded. In FIG. 13, the integrally molded resin 131 is depicted in separation for an easier depiction. In a completed state of the battery pack 120, the integrally molded resin 131 is interposed between the upper part of the unit cell 121 and the exterior cover 129 so as to be integrated together with them.

A case bottom cover 132 is stuck to a lower portion of the unit cell 121 via a double-sided tape 133. A label 134 is stuck all around the unit cell 121.

FIG. 14 shows a main-part perspective view of a state that the component members of the battery pack of FIG. 13 are assembled together. In the structure of FIG. 13, the protective circuit and the protective elements are integrated in the upper part of the unit cell 121, making it possible to realize a thinner and smaller battery pack in the completed state as shown in FIG. 14.

In the structure of FIG. 14, on the other hand, the unit cell 121 and the integrally molded resin 131 are separate structural bodies. Also, as the resin to be injected to between the unit cell 121 and the exterior cover 129, a relatively soft resin material (e.g., polyamide resin) is used in consideration of chargeability to that narrow portion or the like. The unit cell 121, which is formed from a metal material (aluminum or aluminum alloy etc.), is basically not joined to such a resin material.

Therefore, as shown in FIG. 14, when an external force causes a torsion, i.e. twist T or bend M, to act on the integrally molded resin 131, the force acts so that the integrally molded resin 131 is separated from the unit cell 121. In this case, when an increased external force is applied, there could occur deformation or fracture of the exterior part.

Particularly in recent years, it has more often been becoming the case that such battery packs to be used in portable electronic equipment or the like are carried in one battery pack alone as an auxiliary battery pack in addition to a battery pack mounted the portable electronic equipment main unit. In such a case where the battery pack is carried by itself alone, unforeseen external force may be applied to the battery pack. Thus, there is a desire for improving the mechanical strength of the battery pack alone.

In order to solve these and other problems, various structures are proposed. For example, Documents 1 and 2 below show proposals for screwing a cover portion to the unit cell. Documents 3 to 5 below propose structures in which resin mold is integrally molded with the unit cell, where a protruding portion is embedded into the resin mold. Documents 6 and 7 propose that connecting components are interposed between the cover portion and the unit cell to bind the two members together.

Document 1: JP 2008-112725 A

Document 2: JP 2006-164531 A

Document 3: JP 2007-165328 A

Document 4: JP 2003-282039 A

Document 5: JP 2005-129528 A

Document 6: JP 2006-236735 A

Document 7: JP 2004-319144 A

### SUMMARY OF THE INVENTION

However, in the structures proposed in the Documents shown above, although the binding power between exterior part and unit cell can be enhanced, there arises a need for adding new component members such as screws, a protruding portion and connecting components while the structure becomes more complex.

The present invention having been accomplished to solve the above-described issues, an object of the invention is to provide a battery pack, as well as a manufacturing method therefor, which can secure the reliability of mechanical strength of the exterior part with a simple structure.

In order to achieve the above object, the present invention has the following constitutions.

According to a first aspect of the present invention, there is provided a battery pack comprising:

a unit cell having a terminal portion;

accessory parts for extracting electricity from the unit cell to outside of the battery pack; and

an exterior member which covers the terminal portion of the unit cell and the accessory parts, wherein

the accessory parts include

a strip-shaped electrical-connection use lead which is connected to the terminal portion of the unit cell by welding so as to electrically connect the terminal portion and the accessory parts to each other, and

a frame having an engagement portion with the lead and holding the exterior member.

According to a second aspect of the present invention, there is provided a battery pack comprising:

a unit cell having a terminal portion;

accessory parts for extracting electricity from the unit cell to outside of the battery pack; and

an exterior member which covers the terminal portion of the unit cell and the accessory parts, wherein

the accessory parts include

a strip-shaped electrical-connection use lead which is connected to the terminal portion of the unit cell by welding so as to electrically connect the terminal portion and the accessory parts to each other, and wherein

an opening through which the lead is set as well as protruding portions inwardly protruded from inner peripheral surfaces of the opening are formed in the frame,

mutually opposed inner peripheral surfaces of the opening of the frame are used as engagement portions, and widthwise both end faces of the strip-shaped lead are set into contact with the inner peripheral surfaces, whereby the frame is engaged with the lead in the widthwise direction of the lead, and

at welding-connecting portions between the lead and the terminal portion of the unit cell, a unit cell-side surface of the lead, formed so as to have a larger size in a widthwise direction of the strip-shaped lead than the terminal portion of the unit cell and protruded in the widthwise direction from the terminal portion, is engaged with the protruding portions.

According to a third aspect of the present invention, there is provided a battery pack manufacturing method comprising:

positioning a frame relative to a unit cell so that a terminal portion formed in one end face of the unit cell is positioned within an opening of the frame;

setting a strip-shaped electrical-connection use lead so that inner peripheral surfaces of the opening of the frame and widthwise end faces of the lead are put into contact with each other, whereby the lead is set onto the terminal portion exposed from the opening;

welding the lead and the terminal portion each other thereby fixing the frame at least in a widthwise direction of the strip-shaped lead; and then

fitting an exterior member to the frame so that the terminal portion, the lead and the frame are covered therewith.

According to the present invention, in the battery pack, the reliability of mechanical strength of the exterior part can be secured with a simple structure.

### BRIEF DESCRIPTION OF THE DRAWINGS

These aspects and features of the present invention will become clear from the following description taken in conjunction with the preferred embodiments thereof with reference to the accompanying drawings, in which:

FIG. 1 is an exploded perspective view of a battery pack according to one embodiment of the present invention;

FIG. 2 is a perspective view of the battery pack according to the embodiment;

FIG. 3 is an enlarged view of an upper part of the unit cell in FIG. 1 before setting of the exterior cover;

FIG. 4 is a perspective view showing a state in which the resin mold is integrally molded with the upper part of the unit cell in this embodiment;

FIG. 5 is a perspective view showing a state in which a negative lead and a positive lead are welded to the unit cell in FIG. 1;

FIG. 6 is a sectional view taken along the line A-A of FIG. 5;

FIG. 7 is a sectional view taken along the line B-B of FIG. 5;

FIG. 8 is a perspective view showing a frame, the negative lead and the positive lead according to the embodiment;

FIG. 9 is a perspective view showing the insert-molded frame according to the embodiment;

FIG. 10 is an exploded perspective view of part of accessory parts in a battery pack according to another embodiment of the invention;

FIG. 11 is a perspective view showing a state that a third lead in addition to the negative lead and the positive lead is welded to the unit cell from the state of FIG. 10;

FIG. 12 is a sectional view taken along the line C-C of FIG. 11;

FIG. 13 is an exploded perspective view of an example of a conventional battery pack; and

FIG. 14 is a perspective view of a main part of a state in which individual components of the conventional battery pack of FIG. 13 are assembled together.

### DETAILED DESCRIPTION OF THE PREFERRED EMBODIMENTS

According to the battery pack of the invention, while the lead is engaged with the engagement portion provided in the frame, the lead is bonded to the terminal portion provided in the unit cell by welding. As a result of this, movement of the frame caused by action of any external force can be suppressed. That is, in the structure in which an exterior member is fitted to the frame, movement of those members can be suppressed under action of any external force on the exterior member, so that the reliability of mechanical strength of the exterior part can be secured with a simple structure.

Preferably, in the battery pack, an opening through which the lead is set is formed in the frame, and with mutually opposed first inner peripheral surfaces of the opening of the frame serving as engagement portions, widthwise both end faces of the strip-shaped lead are set into contact with the first inner peripheral surfaces, whereby the frame is engaged with the lead in a widthwise direction of the lead. With this constitution, the mechanical strength for external force applied at least in the widthwise direction of the lead can be enhanced, and particularly movement of the frame under action of torsion can be prevented.

Preferably, second inner peripheral surfaces crossing with the first inner peripheral surfaces of the opening of the frame are used as further engagement portions, and longitudinal end faces of the strip-shaped lead are set into contact with the engagement portions, whereby the frame is engaged with the lead in the longitudinal direction of the lead. With this constitution, the mechanical strength for external force applied in the longitudinal direction of the lead as well as in its widthwise direction can be enhanced, and particularly movement of the frame under action of torsion can be prevented.

Preferably, protruding portions inwardly protruded from the mutually opposed first inner peripheral surfaces of the opening of the frame are formed as further engagement portions, and a unit cell-side surface of the strip-shaped lead is set into contact with the protruding portions, whereby the frame is engaged with the lead in a thicknesswise direction of the lead. With this constitution, the mechanical strength for external force applied in the thicknesswise direction of the lead can be enhanced, and particularly movement of the frame under action of bend can be prevented. Further, when this engagement of the lead in the thicknesswise direction is combined with the above-described engagement of the lead in the widthwise and longitudinal directions, the mechanical strength for both torsion and bend can be enhanced.

Preferably, at welding-connecting portions between the lead and the unit cell, the unit cell-side surface of the lead formed so as to have a larger size in a widthwise direction of the strip-shaped lead than the terminal portion of the unit cell and protruded in the widthwise direction from the terminal portion is engaged with the protruding portion.

Preferably, a restricting surface on which a unit cell-side surface of the lead set through the opening of the frame is to be superposed is formed in at least part of a peripheral edge of the opening, and the frame is engaged with the lead in a thicknesswise direction of the lead with the restricting surface used as a further engagement portion. Also with this constitution, movement of the frame under action of bend can be prevented.

Preferably, the engagement portion of the frame is formed integrally with the lead by insert molding. With this constitution, the step for making the lead engaged with the frame can be omitted in the assembly process (manufacturing process) of the battery pack.

Preferably, the unit cell has a flat quadrilateral shape whose depth is smaller in comparison to its longitudinal height and lateral length, and exterior members and accessory parts are mounted on mounting surfaces which are given by longitudinal end faces of the unit cell, where a widthwise direction of the strip-shaped lead is the depthwise direction and its thicknesswise direction is the longitudinal direction, and where terminal portions are provided at lateral both end portions, respectively, of the mounting surface of the unit cell, and a plurality of engagement portions are provided in the frame so as to correspond to the individual terminal portions, respectively. With this constitution, there is provided a further advantage in securing the mechanical strength of the exterior part.

According to the battery pack manufacturing method of the invention, the method includes: positioning a frame relative to a unit cell so that a terminal portion formed in one end face of the unit cell is positioned within an opening of the frame; setting a strip-shaped electrical-connection use lead so that an inner peripheral surface of the opening of the frame and a widthwise end face of the lead are put into contact with each other, whereby the lead is set onto the terminal portion exposed from the opening; and welding the lead and the terminal portion to each other to thereby fix the frame at least in the widthwise direction of the strip-shaped lead. With this method, the positioning of the lead relative to the terminal portion is facilitated by using the frame, and thereafter welding the lead to the terminal portion makes it possible to enhance the mechanical strength of the frame or the like for external force applied at least in the widthwise direction of the lead can be enhanced. Thus, a battery pack which can be prevented particularly from movement of the frame under action of torsion can be manufactured with high productivity.

Also, when the frame is engaged with the lead also in its longitudinal direction, the mechanical strength of the frame or the like for external force applied in the same direction can be enhanced. Thus, movement of the frame under action of torsion can be prevented more effectively.

Also, when the frame is engaged with the lead also in its thicknesswise direction, the mechanical strength of the frame or the like for external force applied in the same direction can be enhanced. Thus, movement of the frame under action of bend as well as torsion can be prevented.

Before the description of the present invention proceeds, it is to be noted that like parts are designated by like reference numerals throughout the accompanying drawings.

Hereinbelow, an embodiment of the present invention will be described in detail with reference to the accompanying drawings.

### First Embodiment

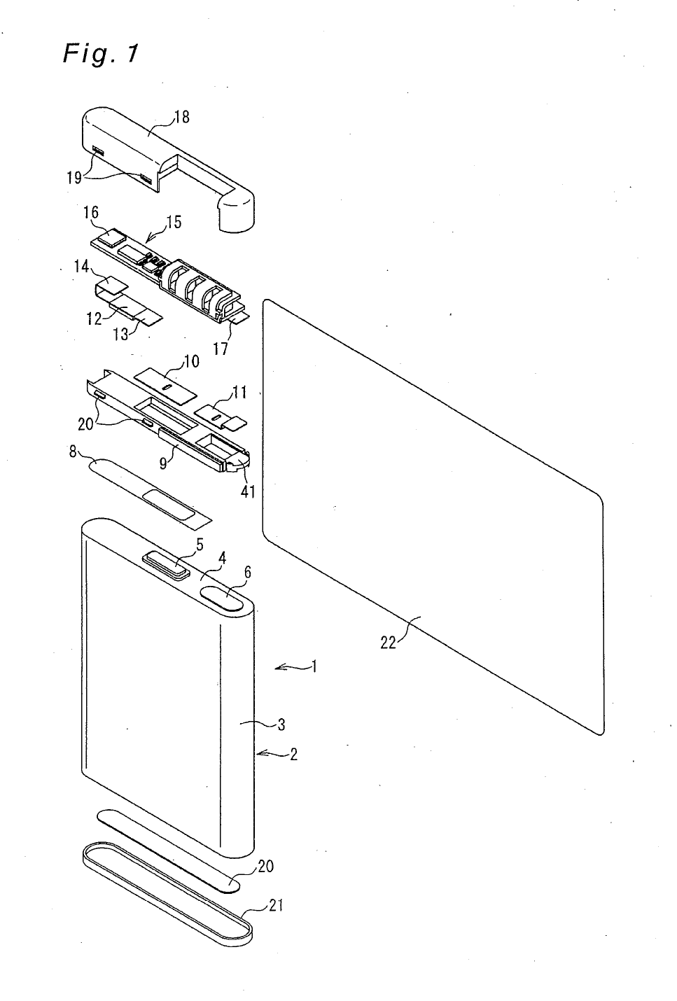

First, an outlined constitution of the battery pack is described with reference to FIG. 1. FIG. 1 is an exploded perspective view of a battery pack 1 according to one embodiment of the present invention. FIG. 1 shows a unit cell 2 and various accessory parts to be fitted thereto. The unit cell 2 is so made up that power generation elements are contained in a smaller-in-thickness, rectangular-shaped exterior case 3 formed from aluminum or aluminum alloy as an example. The unit cell 2 is a rectangular-shaped lithium ion battery, as an example, which is used in mobile phones, mobile equipment or the like. It is noted that the term “accessory parts” refers to various types of component parts for extracting electricity from the unit cell 2 to outside of the battery pack 1. Also, the battery pack 1 has a thinned flat quadrilateral shape whose depth is smaller in comparison to its longitudinal height and lateral length.

An opening portion of the exterior case 3 is sealed by a sealing member 4. The sealing member 4 is provided with a negative terminal 5 and a positive terminal 6. A resin-made frame 9 is fitted to the sealing member 4 via double-sided tape 8.

A negative lead 10 is bonded to the negative terminal 5 by welding, and a positive lead 11 is bonded to the positive terminal 6 by welding. A one-end terminal 13 of a protective element 12 is bonded to the negative lead 10. Material of the negative lead 10 and the positive lead 11 may be decided in accordance with the material of the negative terminal 5 and the positive terminal 6, examples of the material including nickel, iron, stainless steel and the like. The negative lead 10 and the positive lead 11 are formed as strip-shaped members.

The other-end terminal 14 of the protective element 12 is bonded to a terminal 16 of the board-like protective circuit 15 by welding. A lead 17 of the protective circuit 15 is bonded to the positive lead 11 by welding. The protective element 12 and the protective circuit 15 are protection means for preventing overcharge, overcurrents, overdischarge and the like.

Holes 19 of an exterior cover 18 (exterior member), which is a resin molded article, and fixing claws of the frame 9 are engaged with each other, respectively, by which the exterior cover 18 is fixed to the frame 9. At a lower portion of the unit cell 2, a case bottom cover 21 is fitted via the double-sided tape 8. A label 22 is stuck all around the unit cell 2. In addition, the frame 9 has electric insulation property as an example. Also, from a viewpoint that the exterior cover 18 is supported by the frame 9, preferably, the frame 9 is made from a resin material having such rigidity as to withstand external force such as torsion and bend. Materials for forming the frame 9 include polycarbonate.

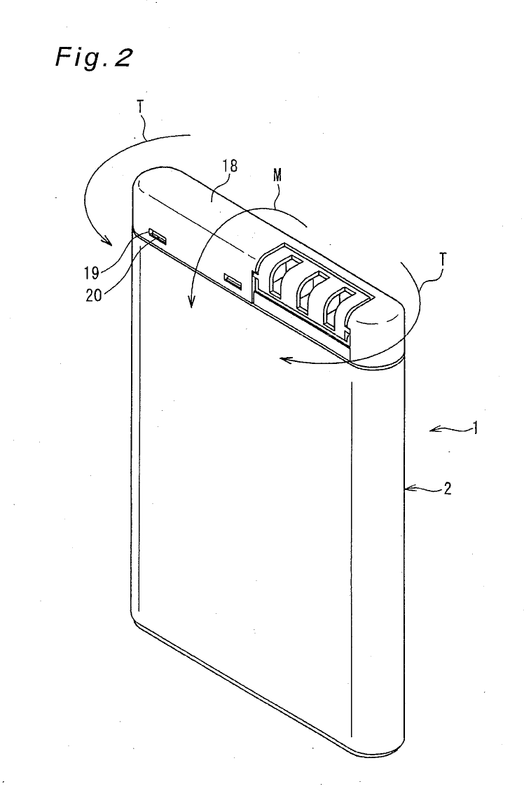

FIG. 2 is a perspective view of the battery pack 1 in a completely assembled state. In the state of FIG. 2, various accessory parts shown in FIG. 1 are housed in the exterior cover 18.

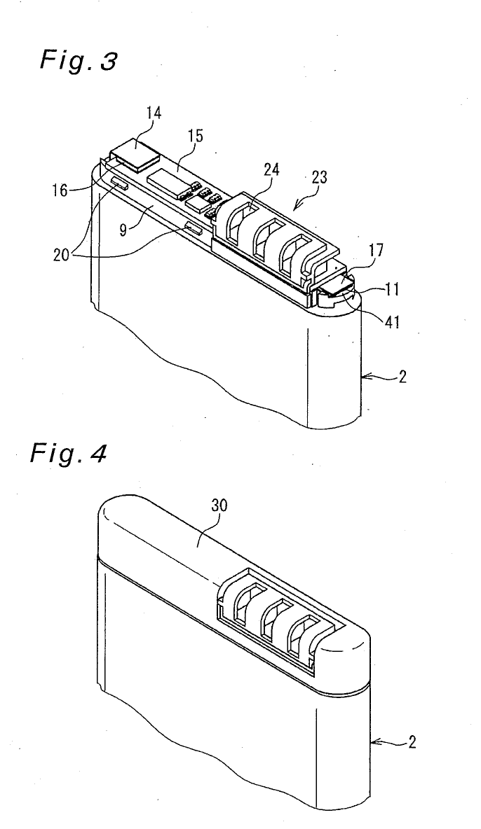

FIG. 3 is an enlarged view of an upper part of the unit cell 2 before setting of the exterior cover 18 in FIG. 1. The frame 9 supports the protective circuit 15. On the protective circuit 15, various electrical parts are mounted. Further to the protective circuit 15, a contact pad 23 is fitted. The contact pad 23 has openings 24 formed therein, and external-connection terminals are to be fitted at the positions of the openings 24. It is noted that the accessory parts include the frame 9, the protective circuit 15, the contact pad 23, the external-connection terminals, the leads and the like in this embodiment.

The other-end terminal 14 of the protective element 12 (FIG. 1) is bonded to the terminal 16 of the protective circuit 15 by welding. The positive lead 11 is bonded to the lead 17 of the protective circuit 15 by welding.

Electrical connections are completed in the state of FIG. 3. In this state, fitting the exterior cover 18 shown in FIG. 1 to the frame 9 results in the state shown in FIG. 2. The hole 19 of the exterior cover 18 and the fixing claws 20 of the frame 9 are engaged with each other, respectively, by which the exterior cover 18 is fixed to the frame 9.

FIG. 4 is a perspective view showing another structure of the upper part of the unit cell 2. The structure of this figure, as shown in FIG. 2, is that a resin mold 30 is integrally molded in an upper part of the unit cell 2 instead of setting the exterior cover 18. The resin mold 30 can be molded by mounting the unit cell 2, which is in the state shown in FIG. 3, onto a metal mold and then filling resin into a space surrounded by the mold in the upper part of the unit cell 2. In the structure of FIG. 4, various accessory parts shown in FIG. 1 are integrally buried within the resin mold 30. It is noted that since such resin in the resin mold 30 covers the various accessory parts attached on the upper face of the unit cell 2 to make up an integrated resin mold 30, the resin can be said to be another embodiment of the exterior member that covers the positive terminal 6, the negative terminal 5 and various accessory parts on the upper face of the unit cell 2.

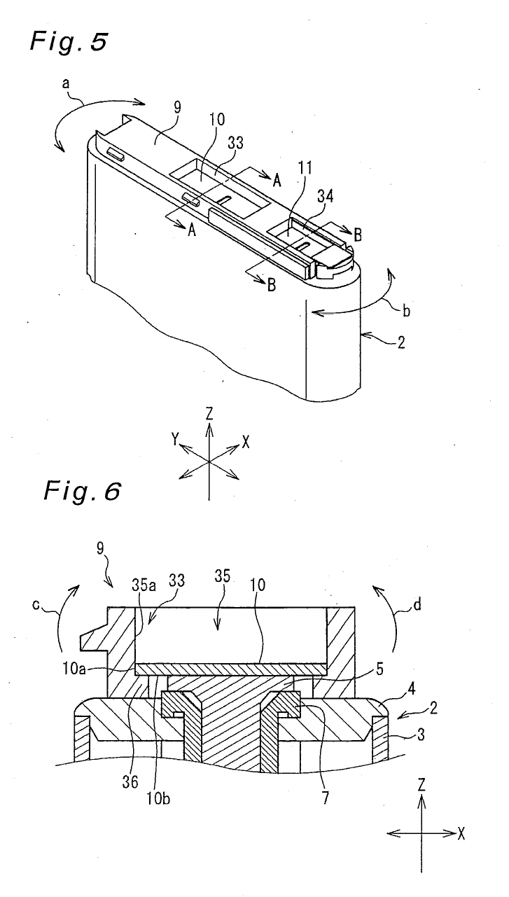

FIG. 5 is a perspective view showing a state in which the negative lead 10 and the positive lead 11 are welded to the unit cell 2 in FIG. 1. The negative lead 10 is engaged to an engagement portion 33 formed in the frame 9. Similarly, the positive lead 11 is engaged to an engagement portion 34.

In the state of FIG. 5, the negative lead 10 is bonded to the negative terminal 5 (FIG. 1) of the unit cell 2 by welding, and the positive lead 11 is bonded to the positive terminal 6 (FIG. 1) of the unit cell 2 by welding. Therefore, the negative lead 10 and the positive lead 11 are never positionally moved in the thicknesswise direction (X direction), widthwise direction (Y direction) or heightwise direction (Z direction) of the unit cell 2. In addition, in this embodiment, the widthwise direction of the negative lead 10 and the positive lead 11, which are strip-shaped members, is the X direction, their longitudinal direction is the Y direction, and their thicknesswise direction is the Z direction.

FIG. 6 is a sectional view taken along the line A-A of FIG. 5. The opening of the exterior case 3 is sealed by the sealing member 4. The negative terminal 5 is fitted to the sealing member 4 via an insulator 7. An opening 35 is formed in the engagement portion 33 of the frame 9, and widthwise end faces 10a of the negative lead are in contact with opposed-in-X-direction inner peripheral surfaces (first inner peripheral surfaces) 35a of the opening 35, respectively. As a result of this, the frame 9 is set into such a state as to be engaged with the negative lead 10 in the X direction.

As described before, the negative lead 10 is welded to the negative terminal 5 by welding, and positionally moved in neither the X direction, the Y direction nor the Z direction shown in FIG. 5. As a result of this, when external force acts on the frame 9 engaged with the negative lead 10, the frame 9 is inhibited from positional movement in the X direction. Further, its movement in rotational directions shown by arrows a, b of FIG. 5 is also inhibited.

In the opening 35, longitudinal end faces of the negative lead 10 are in contact with opposed-in-Y-direction inner peripheral surfaces (second inner peripheral surfaces) in addition to the opposed-in-X-direction inner peripheral surfaces 35a. As a result of this, the frame 9 is set into such a state as to be engaged with the negative lead 10 further in the Y direction. Thus, when external force acts on the frame 9 engaged with the negative lead 10, the frame 9 is inhibited from positional movement in the Y direction. Further, its movement in rotational directions shown by arrows a, b of FIG. 5 can be inhibited more effectively.

Protruding portions 36 are inwardly protruded from the inner peripheral surfaces 35a of the opening 35. A one-side surface 10b (i.e., a surface 10b on the unit cell 2 side) of the negative lead 10 is in contact with the protruding portions 36. As a result of this, the frame 9 is set into such a state as to be engaged with the negative lead 10 in the X direction. Thus, when external force acts on the frame 9, the frame 9 is inhibited from positional movement in the Z direction. Further, its movement in rotational directions shown by arrows c, d of FIG. 6 is also inhibited.

For fulfillment of the engagement in the Z direction between the protruding portions 36 of the opening 35 as shown in FIG. 6 and the negative lead 10, preferably, the negative lead 10 is so formed that the width in the X direction of the negative lead 10 becomes larger than the size in the same direction of the negative terminal 5. By forming the negative lead 10 and the negative terminal 5 in this way, both-end edges of the negative lead 10 can be protruded from the negative terminal 5 outward of the X direction at bonding portions by their welding, so that those protruded both-end edges can be engaged with the protruding portions 36 of the opening 35. Also, since the protruding portions 36 of the frame 9 having insulating property are placed interveniently between both-end edges of the protruding negative lead 10 and the sealing member 4 formed from a metal material, the negative lead 10 can reliably be prevented from making contact with the sealing member 4.

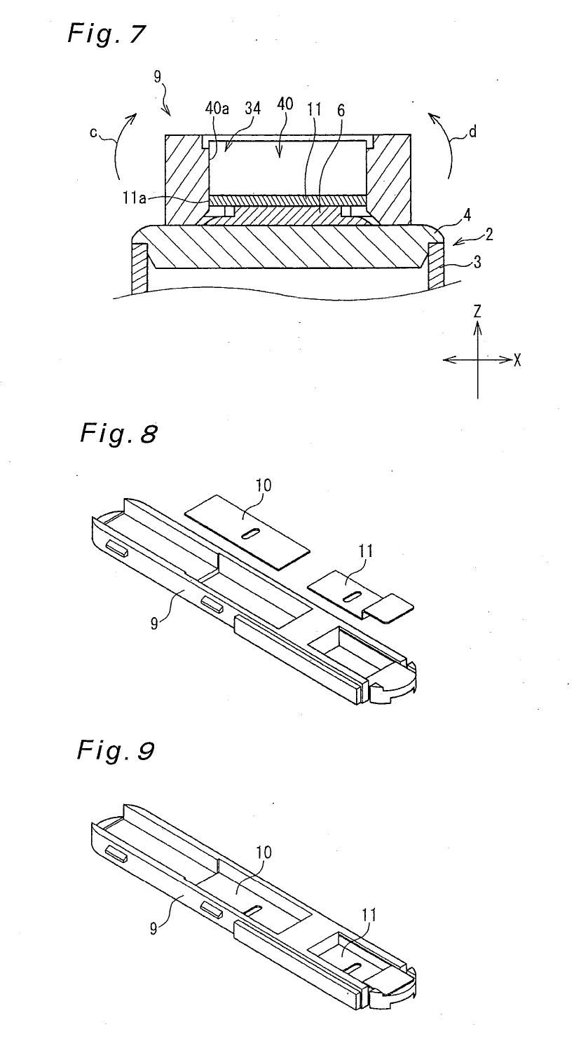

FIG. 7 is a sectional view taken along the line B-B of FIG. 5. The positive terminal 6 is bonded to the sealing member 4 by welding. An opening 40 is formed in the engagement portion 34 of the frame 9, and widthwise end faces 11a of the positive lead 11 are in contact with opposed-in-X-direction inner peripheral surfaces 40a (first inner peripheral surfaces) of the opening 40, respectively. As a result of this, the frame 9 is set into such a state as to be engaged with the positive lead 11 in the X direction.

As described before, the positive lead 11 is welded to the positive terminal 6 by welding, and positionally moved in neither the X direction, the Y direction nor the Z direction shown in FIG. 5. As a result of this, when external force acts on the frame 9 engaged with the positive lead 11, the frame 9 is inhibited from positional movement in the X direction. Further, its movement in rotational directions shown by arrows a, b of FIG. 5 is also inhibited.

In the opening 40, longitudinal end faces of the positive lead 11 are in contact with opposed-in-Y-direction inner peripheral surfaces (second inner peripheral surfaces) in addition to the opposed-in-X-direction inner peripheral surfaces 40a. As a result of this, the frame 9 is set into such a state as to be engaged with the positive lead 11 further in the Y direction. Thus, when external force acts on the frame 9 engaged with the positive lead 11, the frame 9 is inhibited from positional movement in the Y direction. Further, its movement in rotational directions shown by arrows a, b of FIG. 5 can be inhibited more effectively.

The engagement portion 34 includes the restricting surface 41 shown in FIG. 1. The restricting surface 41 is a flat portion serving as a seat for part of the positive lead 11. As shown in FIGS. 3 and 5 or the like, a one-side end portion of the positive lead 11 placed through the opening 40 is bent stepwise while this end portion of the positive lead 11 is superposed on the restricting surface 41 formed in part of upper-surface side peripheral edges of the opening 40. As a result of this, the end portion of the positive lead 11 and the restricting surface 41 are engaged with each other in the Z direction. Thus, when external force acts on the frame 9, the frame 9 is inhibited from positional movement in the Z direction. Further, its movement in rotational directions shown by arrows c, d of FIG. 7 is also inhibited.

In particular, as shown in FIG. 7, in a case where the width in the X direction of the positive lead 11 cannot be set larger than the width in the same direction of the positive terminal, using such a restricting surface 41 makes it possible to achieve reliable engagement between the frame 9 and the positive lead 11 in the Z direction.

Also, as shown in FIG. 3, with the positive lead 11 placed on the restricting surface 41, making the lead 17 superposed on the positive lead 11 makes it easily achievable to bond superposing place between the lead 17 and the positive lead 11 by spot welding. During the spot welding, the restricting surface 41 can function as a seat for receiving the two leads 11, 17.

In FIG. 7, no shape corresponding to the protruding portion 36 of FIG. 6 is provided in the inner peripheral surfaces 40a. However, the specifications may include provision of such a shape.

Also, this embodiment adopts a structure in which the frame 9 is engaged with the negative lead 10 and the positive lead 11 welded to the negative terminal 5 and the positive terminal 6 of the unit cell 2, so that the frame 9 is fixed. From such a point of view, desirably, the material, thickness and the like of the negative lead 10 and the positive lead 11 are so set that necessary rigidity can be ensured. For example, when nickel is used as a lead material, its thickness is preferably increased to about 0.15 mm to 0.2 mm, thicker than conventional ones.

In the completed-product state of the battery pack 1, as shown in FIG. 2, the exterior cover 18 is fitted to the upper part of the unit cell 2. The frame 9 is accommodated in the exterior cover 18, and the exterior cover 18 is fitted to the frame 9. Therefore, when an external force causes a torsion, i.e. twist T or bend M, to act on the exterior cover 18, the force acts so that the exterior cover 18 is separated from the unit cell 2. In this case, the frame 9 fixed to the exterior cover 18 tends to be integrally displaced.

Meanwhile, as described before, the frame 9 is inhibited from movement in rotational directions shown by arrows a, b of FIG. 5. Due to this, even if the twist T shown in FIG. 2 acts on the exterior cover 18, displacement of the exterior cover 18 is inhibited.

Next, referring to FIG. 2, when the bend M acts on the exterior cover 18, a force that causes the exterior cover 18 to be floated from the top portion of the unit cell 2 acts on the exterior cover 18. In this case, the frame 9 fixed to the exterior cover 18 tends to be integrally displaced.

Meanwhile, as described before, the frame 9 is inhibited from movement in rotational directions shown by arrows c, d of FIGS. 6 and 7. Due to this, even if the bend M shown in FIG. 2 acts on the exterior cover 18, displacement of the exterior cover 18 is inhibited.

Inhibition of displacement of the exterior cover 18 has been described above by the example of FIG. 2. This is the case also when the resin mold 30 is integrally molded as shown in FIG. 4. That is, even when external force acts on the resin mold 30, the frame 9 integrated as the resin mold 30 is inhibited from movement, so that displacement of the resin mold 30 is inhibited.

Accordingly, with the structure of this embodiment, even if the twist T or bend M acts on the exterior cover 18, displacement of the exterior cover 18 or the resin mold 30 is inhibited, making it possible to secure the reliability of the mechanical strength of the exterior part. Also, there is no need for adding any exclusive component parts for securement of the mechanical strength. Thus, no increases in parts counts or production man-hours are involved, so that cost increases can be suppressed.

Further, also for the unit cell 2, there is no need for adding processes or exclusive component parts, and the unit cell 2 may be designed for commonization with other device models. This is also advantageous in terms of cost.

FIG. 8 is a perspective view showing the frame 9, the negative lead 10 and the positive lead 11. The frame 9, the negative lead 10 and the positive lead 11 can be treated as individual separate component parts, respectively, in the state of FIG. 8. In this case, in the example of FIG. 1, after the frame 9 is fitted to the sealing member 4 with double-sided tape 8, the negative lead 10 and the positive lead 11 are engaged with engagement portions 33, 34 as shown in FIG. 5.

More specifically, in order that the negative terminal 5 and the positive terminal 6 of the sealing member 4 are located within the opening 35, 40 of the frame 9, the frame 9 is positioned relative to the sealing member 4 and so fitted to the sealing member 4 with the double-sided tape 8. Thereafter, the negative lead 10 and the positive lead 11 are so placed as to be fitted into the opening 35, 40 of the frame 9, by which the negative lead 10 and the positive lead 11 can be set in a proper place relative to the negative terminal 5 and the positive terminal 6. In this state, performing spot welding from the upper surface side of the negative lead 10 and the positive lead 11 allows the negative lead 10 to be bonded to the negative terminal 5 and moreover the positive lead 11 to be bonded to the positive terminal 6, so that the frame 9 can securely be engaged with those leads 10, 11. Accordingly, assembling work of the battery pack 1 can be achieved more efficiently, so that the productivity can also be improved.

Meanwhile, the negative lead 10 and the positive lead 11 may be integrated to the frame 9 in advance. Such integration is suitably achieved by insert molding.

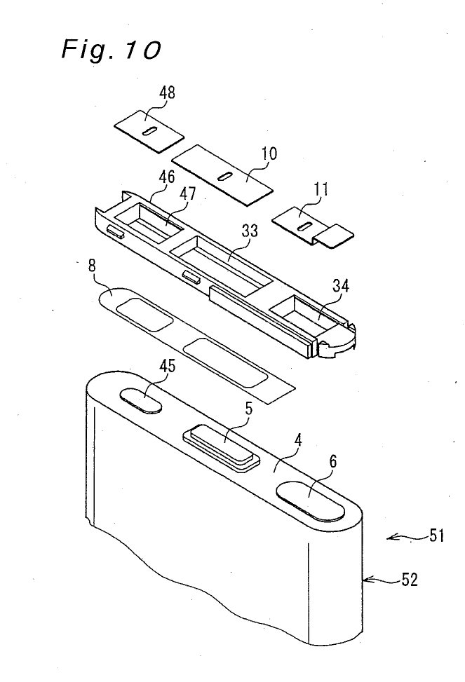

FIG. 9 is a perspective view showing the insert-molded frame 9. The negative lead 10 and the positive lead 11 are bonded to the frame 9 of FIG. 9 by insert molding. More specifically, with the negative lead 10 and the positive lead 11 inserted in a mold in advance, resin is injected into the mold, by which a molded article of the frame 9 and the negative lead 10 and the positive lead 11 that have been integrated together can be obtained.

With use of the frame 9 shown in FIG. 9, a step for making the negative lead 10 and the positive lead 11 engaged with the frame 9 can be omitted in the battery pack assembling process.

### Second Embodiment

A battery pack according to Embodiment 2 will be described below. Whereas two terminal portions are included in the unit cell 2 in Embodiment 1, three terminal portions are included in this embodiment. Due to this, the frame structure is changed with the lead count increased by one. Except for this point, this embodiment is similar in structure to Embodiment 1. Therefore, the same component members as in Embodiment 1 are designated by the same reference signs and their description is omitted.

FIG. 10 is an exploded perspective view of part of accessory parts in a battery pack 51 according to Embodiment 2. Shown in this figure are component parts involved up to the bonding of leads to a unit cell 52. Basic component members of the accessory parts after the bonding of the leads to the unit cell 52 are similar to those of Embodiment 1, and their description is omitted.

A third terminal 45 is provided in the sealing member 4 in addition to the negative terminal 5 and the positive terminal 6. The third terminal 45 may be either positive or negative. In this connection, a third engagement portion 47 is formed in a frame 46 in addition to the engagement portions 33, 34. Further, a third lead 48 is provided in addition to the negative lead 10 and the positive lead 11. The frame 46 is fitted to the sealing member 4 via the double-sided tape 8.

FIG. 11 is a perspective view showing a state that the third lead 48 in addition to the negative lead 10 and the positive lead 11 is welded to the unit cell 52 from the state of FIG. 10. The negative lead 10 is engaged with the engagement portion 33 formed in the frame 46, and the positive lead 11 is engaged with the engagement portion 34. Further, the third lead 48 is engaged with the third engagement portion 47.

In the state of FIG. 11, the negative lead 10 is bonded to the negative terminal 5 of the unit cell 52 by welding, while the positive lead 11 is bonded to the positive terminal 6 of the unit cell 52 by welding. Further, the third lead 48 is bonded to the third terminal 45 by welding.

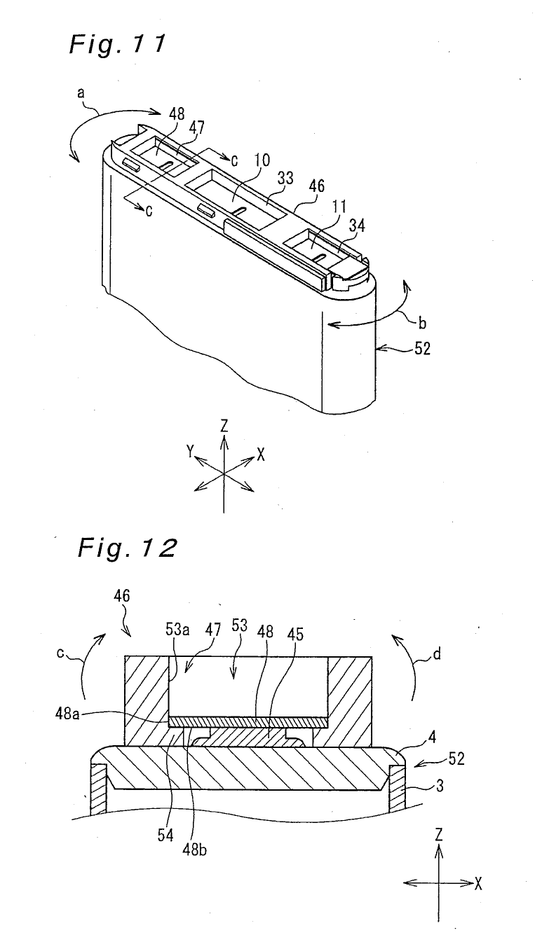

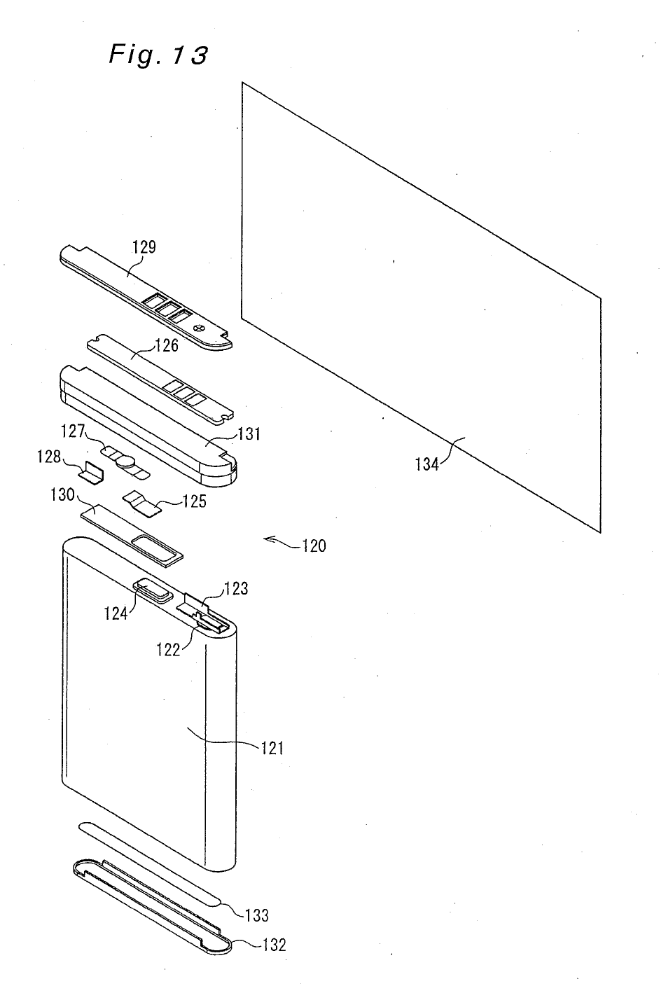

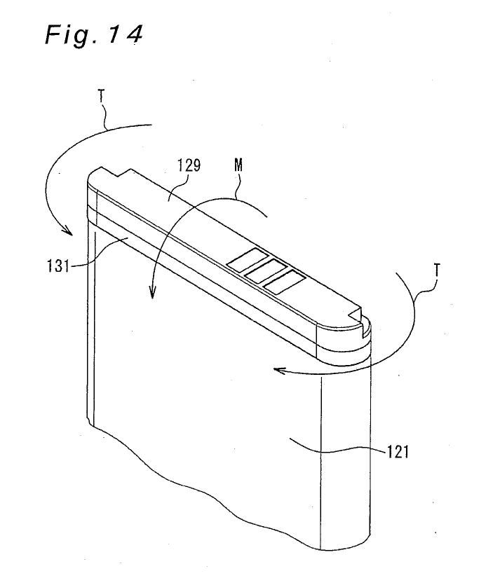

FIG. 12 is a sectional view taken along the line C-C of FIG. 11. A cross-sectional structure shown in FIG. 12 is similar to a cross-sectional structure of a vicinity of the negative terminal 5 shown in FIG. 6. Therefore, similar effects as those of the cross-sectional structure shown in FIG. 6 can be obtained also with the cross-sectional structure shown in FIG. 12. Details of this are as described below.

The third terminal 45 is fitted to the sealing member 4. The third lead 48 is bonded to this third terminal 45 by welding. Therefore, the third lead 48 is positionally moved in neither the thicknesswise direction (X direction), the widthwise direction (Y direction) nor the heightwise direction (Z direction) of the unit cell 2 shown in FIG. 10.

An opening 53 is formed in the engagement portion 47 of the frame 46, and an end face 48a of the third lead 48 is engaged with an inner peripheral surface 53a of the opening 53. As a result of this, when external force acts on the frame 46, the frame 46 is inhibited from positional movement in the X direction. Further, its movement in rotational directions shown by arrows a, b of FIG. 11 is also inhibited.

A protruding portion 54 is protruded from the inner peripheral surface 53a of the opening 53. A one-side surface 48b of the third lead 48 is engaged with the protruding portion 54. As a result of this, when external force acts on the frame 46, the frame 46 is inhibited from positional movement in the Z direction. Further, its movement in rotational directions shown by arrows c, d of FIG. 11 is also inhibited.

Accordingly, in Embodiment 2, addition of the cross-sectional structure shown in FIG. 12 gives a further advantage in securing the reliability of mechanical strength of the exterior part, as compared with Embodiment 1. Also, with the structure of Embodiment 2, the positive lead 11 is bonded to longitudinal one end of the accessory-fitting surface of the unit cell 52 as shown in FIG. 11, while the third lead 48 is bonded to the other end. That is, the strength of the exterior part is enhanced at widthwise both ends of the unit cell 52, which also gives a further advantage in securing the reliability of mechanical strength of the exterior part.

In addition, in Embodiments 1 and 2, when leads that are engaged with the frame are bonded to the unit cell, the frame is fixed to the unit cell. Therefore, the double-sided tape 8 (FIGS. 1, 10) between the frame and the unit cell, although still usable for temporary setting of the frame, may be omitted.

Embodiment 1 shows a case in which leads engaged with the frame are bonded to the unit cell by welding at two bonding places, while Embodiment 2 shows a case of three bonding places. However, four or more bonding places may be provided. Also, at least one bonding place helps secure the reliability of mechanical strength of the exterior part.

As described hereinabove, according to the battery pack of the present invention, high reliability of mechanical strength of the exterior part can be ensured with a simple structure. Thus, the battery pack according to the invention is useful as battery packs for use in, for example, mobile phones and mobile equipment.

It is to be noted that, by properly combining the arbitrary embodiments of the aforementioned various embodiments, the effects possessed by them can be produced.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

The entire disclosure of Japanese Patent Application No. 2009-038244 filed on Feb. 20, 2009, including specification, claims, and drawings are incorporated herein by reference in its entirety.

What is claimed is:

1. A battery pack comprising:
a unit cell having a terminal portion;
accessory parts for extracting electricity from the unit cell to outside of the battery pack; and
an exterior member which covers the terminal portion of the unit cell and the accessory parts, wherein
the accessory parts include
a strip-shaped electrical-connection use lead which is connected to the terminal portion of the unit cell by welding so as to electrically connect the terminal portion and the accessory parts to each other, and
a frame having an engagement portion with the lead and holding the exterior member.

2. The battery pack as defined in claim 1, wherein an opening through which the lead is set is formed in the frame, and with mutually opposed first inner peripheral surfaces of the opening of the frame serving as said engagement portion, widthwise both end faces of the strip-shaped lead are set into contact with the first inner peripheral surfaces, whereby the frame is engaged with the lead in a widthwise direction of the lead.

3. The battery pack as defined in claim 2, wherein second inner peripheral surfaces crossing with the first inner peripheral surfaces of the opening of the frame are used as further said engagement portion, and longitudinal end faces of the strip-shaped lead are set into contact with the second inner peripheral surfaces, whereby the frame is engaged with the lead in the longitudinal direction of the lead.

4. The battery pack as defined in claim 3, wherein protruding portions inwardly protruded from the mutually opposed first inner peripheral surfaces of the opening of the frame are formed as further said engagement portion, and a unit cell-side surface of the strip-shaped lead is set into contact with the protruding portions, whereby the frame is engaged with the lead in a thicknesswise direction of the lead.

5. The battery pack as defined in claim 4, wherein at welding-connecting portions between the lead and the unit cell, the unit cell-side surface of the lead, formed so as to have a larger size in a widthwise direction of the strip-shaped lead than the terminal portion of the unit cell and protruded in the widthwise direction from the terminal portion, is engaged with the protruding portions.

6. The battery pack as defined in claim 1, wherein an opening through which the lead is set is formed in the frame, and protruding portions inwardly protruded from mutually opposed inner peripheral surfaces of the opening are formed as further said engagement portion, wherein a unit cell-side surface of the strip-shaped lead is set into contact with the protruding portions, whereby the frame is engaged with the lead in a thicknesswise direction of the lead.

7. The battery pack as defined in claim 2, wherein a restricting surface on which a unit cell-side surface of the lead set through the opening of the frame is to be superposed is formed in at least part of a peripheral edge of the opening, and the frame is engaged with the lead in a thicknesswise direction of the lead with the restricting surface used as further said engagement portion.

8. The battery pack as defined in claim 1, wherein an opening through which the lead is set is formed in the frame, a restricting surface on which a unit cell-side surface of the lead set through the opening of the frame is to be superposed is formed in at least part of a peripheral edge of the opening, and the frame is engaged with the lead in a thicknesswise direction of the lead with the restricting surface used as said engagement portion.

9. The battery pack as defined in claim 1, wherein the engagement portion of the frame is formed integrally with the lead by insert molding.

10. The battery pack as defined in claim 4, wherein the unit cell has a flat quadrilateral shape whose depth is smaller in comparison to its longitudinal height and lateral length, and exterior members and accessory parts are mounted on a mounting surface which is given by a longitudinal end face of the unit cell, where the widthwise direction of the strip-shaped lead corresponds to a depthwise direction of the unit cell and the thicknesswise direction of the lead corresponds to a longitudinal direction of the unit cell.

11. The battery pack as defined in claim 10, wherein terminal portions are provided at lateral both end portions, respectively, of the mounting surface of the unit cell, and a plurality of engagement portions are provided in the frame so as to correspond to the individual terminal portions, respectively.

12. A battery pack comprising:
a unit cell having a terminal portion;
accessory parts for extracting electricity from the unit cell to outside of the battery pack; and
an exterior member which covers the terminal portion of the unit cell and the accessory parts, wherein
the accessory parts include
a strip-shaped electrical-connection use lead which is connected to the terminal portion of the unit cell by welding so as to electrically connect the terminal portion and the accessory parts to each other, and wherein
an opening through which the lead is set as well as protruding portions inwardly protruded from inner peripheral surfaces of the opening are formed in the frame,
mutually opposed inner peripheral surfaces of the opening of the frame are used as engagement portions, and widthwise both end faces of the strip-shaped lead are set into contact with the inner peripheral surfaces, whereby the frame is engaged with the lead in the widthwise direction of the lead, and
at welding-connecting portions between the lead and the terminal portion of the unit cell, a unit cell-side surface of the lead, formed so as to have a larger size in a widthwise direction of the strip-shaped lead than the terminal portion of the unit cell and protruded in the widthwise direction from the terminal portion, is engaged with the protruding portions.

13. A battery pack manufacturing method comprising:
positioning a frame relative to a unit cell so that a terminal portion formed in one end face of the unit cell is positioned within an opening of the frame;
setting a strip-shaped electrical-connection use lead so that inner peripheral surfaces of the opening of the frame and widthwise end faces of the lead are put into contact with each other, whereby the lead is set onto the terminal portion exposed from the opening;
welding the lead and the terminal portion each other thereby fixing the frame at least in a widthwise direction of the strip-shaped lead; and then
fitting an exterior member to the frame so that the terminal portion, the lead and the frame are covered therewith.

14. The battery pack manufacturing method as defined in claim 13, wherein
the lead is placed on the terminal portion exposed from the opening so that the inner peripheral surfaces of the opening of the frame and widthwise and longitudinal end faces of the strip-shaped lead are set into contact with each other, and the lead and the terminal portion are welded each other whereby the frame is fixed in the widthwise and longitudinal directions of the strip-shaped lead.

15. The battery pack manufacturing method as defined in claim 14, wherein
the lead is placed on the terminal portion exposed from the opening so that the inner peripheral surface of the opening of the frame and widthwise and longitudinal end faces of the strip-shaped lead are set into contact with each other while the protruding portions inwardly protruded from the inner peripheral surfaces of the opening of the frame and a unit cell-side surface of the lead are further set into contact with each other, and the lead and the terminal portion are welded each other whereby the frame is fixed in the widthwise, longitudinal and thicknesswise directions of the strip-shaped lead.
